(19) United States
(12) Patent Application Publication
(10) Pub. No.: US 2014/0317013 A1
(43) Pub. Date: Oct. 23, 2014

(54) Virtual Warehouse

(71) Applicant: CloudLogix, LLC, Denver, CO (US)

(72) Inventor: Robert K. Langhorne, III, Grapevine, TX (US)

(21) Appl. No.: 14/254,761

(22) Filed: Apr. 16, 2014

Related U.S. Application Data
(60) Provisional application No. 61/812,948, filed on Apr. 17, 2013.

(51) Int. Cl. G06Q 10/08

(52) U.S. Cl. CPC G06Q 10/083
USPC 705/337

(57) ABSTRACT

Various implementations described herein are directed to a non-transitory computer readable medium having stored thereon computer-executable instructions which, when executed by a computer, may cause the computer to receive a request to ship a predetermined number of a type of goods to a destination location. The computer may identify a selection of goods that correspond to the requested type of goods from a database containing a plurality of goods that are physically stored in more than geographical location. The computer may determine which of the selection of goods are available to be shipped to the destination location based on one or more rules for the geographical locations of the selection of goods. The one or more rules dictate whether goods can be shipped from the geographical locations to the destination location.

### CROSS-REFERENCE TO RELATED APPLICATIONS

This application claims the benefit of U.S. Provisional Patent Application Ser. No. 61/812,948, filed Apr. 17, 2013 and titled SUPPLY CHAIN SOFTWARE, the disclosure of which is incorporated herein by reference.

### BACKGROUND

### DISCUSSION OF THE RELATED ART

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Warehouse management systems may be used to manage inventory. A warehouse management system can maintain a database of goods stored within a warehouse. Warehouse management systems can aid in efficiently controlling the flow of goods in and out of a warehouse.

### SUMMARY

Described herein are implementations of various technologies for determining a selection of goods available to ship to a location. In one implementation, a non-transitory computer-readable medium having stored thereon computer-executable instructions which, when executed by a computer, cause the computer to perform various actions. The actions may include receiving a request to ship a predetermined number of a type of goods to a destination location. The actions may include identifying a selection of goods that correspond to the requested type of goods from a database containing a plurality of goods that are physically stored in more than one geographical location. The actions may include determining which of the selection of goods are available to be shipped to the destination location based on one or more rules for the geographical locations of the selection of goods. The one or more rules dictate whether goods can be shipped from the geographical locations to the destination location.

Described herein are also implementations of various technologies for modifying a database to indicate that a selection of goods is in quarantine. In one implementation, a non-transitory computer-readable medium having stored thereon computer-executable instructions which, when executed by a computer, cause the computer to perform various actions. The actions may include receiving a request to place a type of goods in quarantine. The actions may include identifying a selection of goods that correspond to the requested type of goods from a database containing a plurality of goods that are physically stored in more than one geographical location. The actions may also include modifying the database to indicate that the selection of goods is in quarantine and not to be shipped.

Described herein are also implementations of various technologies for ranking a selection of goods that are available to be shipped. In one implementation, a non-transitory computer-readable medium having stored thereon computer-executable instructions which, when executed by a computer, cause the computer to perform various actions. The actions may include receiving a request to ship a predetermined number of a type of goods to a destination location. The actions may include identifying a selection of goods that correspond to the requested type of goods from a database containing a plurality of goods that are physically stored in more than one geographical location. The actions may include determining which of the selection of goods are available to be shipped to the destination location based on one or more rules for the geographical locations of the selection of goods. The one or more rules dictate whether goods can be shipped from the geographical locations to the destination location. The actions may also include ranking the goods within the selection that are available to be shipped based on their distance from the destination location.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 illustrates a diagram of a virtual warehouse in accordance with implementations of various techniques described herein.

FIG. 2 illustrates a flow diagram of a method for retrieving goods available for shipment in accordance with implementations of various techniques described herein.

FIG. 3 illustrates a flow diagram of a method for selecting goods for shipment based on destination in accordance with implementations of various techniques described herein.

FIG. 4 illustrates a flow diagram of a method for placing goods in quarantine in accordance with various implementations described herein.

FIG. 5 illustrates a schematic diagram of a computing system in which the various technologies described herein may be incorporated and practiced.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

Reference will now be made in detail to various implementations, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and “downwardly”; “below” and “above”; and other similar terms indicating relative positions above or below a given point or element may be used in connection with some implementations of various technologies described herein.

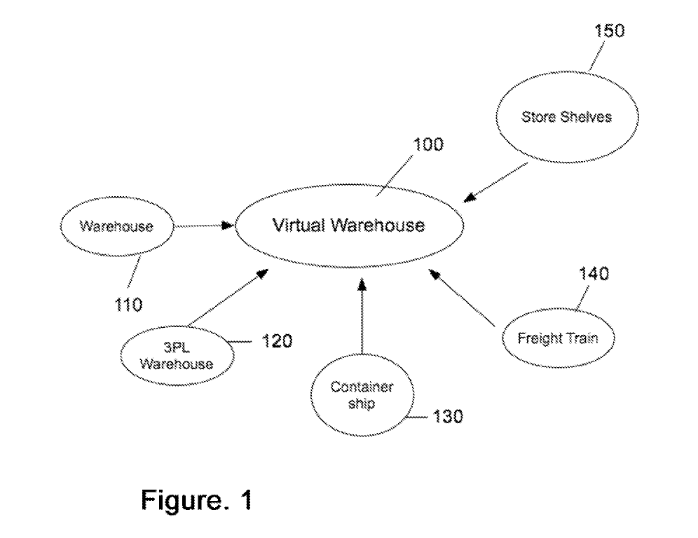

Various implementations of a virtual warehouse will now be described in more detail with reference to FIGS. 1-5.

The following paragraphs provide a brief overview of various implementations of virtual warehouse technologies described herein. In one aspect, various technologies described herein are directed to a virtual warehouse, which is an inventory control and warehouse management system for managing goods throughout a supply chain, regardless of actual location. The virtual warehouse allows the flexibility to manage and store materials in multiple locations. In one implementation, the virtual warehouse may be implemented using a cloud software service. The cloud software service may receive data from other pieces of software, including software at each location where goods are held.

FIG. 1 illustrates a diagram of a virtual warehouse 100 in accordance with implementations of various techniques described herein. The virtual warehouse 100 may manage goods located in multiple locations. As shown in FIG. 1, the virtual warehouse 100 may manage goods in a warehouse 110, a third party logistics (3PL) warehouse 120, a container ship 130, a freight train 140, and goods on store shelves 150.

The virtual warehouse 100 may maintain a database of goods along with a location for those goods. The goods may also be referred to as units of inventory. The database may also contain other information, including more specific location information. For example, the virtual warehouse 100 may describe where in warehouse 110 goods are located. The database may also contain information describing the goods, such as, when the goods were manufactured, when the goods were received, an expiration date for the goods, serial numbers for the goods, part numbers for the goods, model numbers for the goods, or any other information describing the goods.

The virtual warehouse 100 may include a set of location rules, which may contain rules specific to each geographical location where goods within the virtual warehouse are stored. For example, in FIG. 1, the location rules may state that goods can be shipped from warehouse 110 and 3PL warehouse 120, but not from container ship 130, freight train 140, or store shelves 150.

In one example, all of the goods stored in a virtual warehouse 100 are owned by Company A, the organization that maintains the virtual warehouse 100. In this example, warehouse 110 may be a warehouse owned by Company A. Every good contained in warehouse 110 may be in the virtual warehouse 100. 3PL warehouse 120 may be owned by a third party, i.e., not Company A. The 3PL warehouse 120 may contain goods owned by more than one organization. Although 3PL warehouse 120 contains goods from more than one organization, only the goods owned by Company A are included in the virtual warehouse 100. Container ship 130 may be a ship that is in transit and that ships goods owned by Company A. The goods on container ship 130 owned by Company A are included in the virtual warehouse 100. Freight train 140 may be a train that is in transit and that ships goods owned by Company A. The goods on freight train 140 owned by Company A are included in the virtual warehouse 100. Store shelves 150 may comprise goods that are on store shelves, but are still owned by Company A, i.e., title to the goods has not transferred from Company A. These goods may be in stores that are owned by Company A. Or, the goods may be held in stores not owned by Company A, where ownership does not transfer until individual goods are sold. Regardless, the goods on store shelves 150 are included in the virtual warehouse 100.

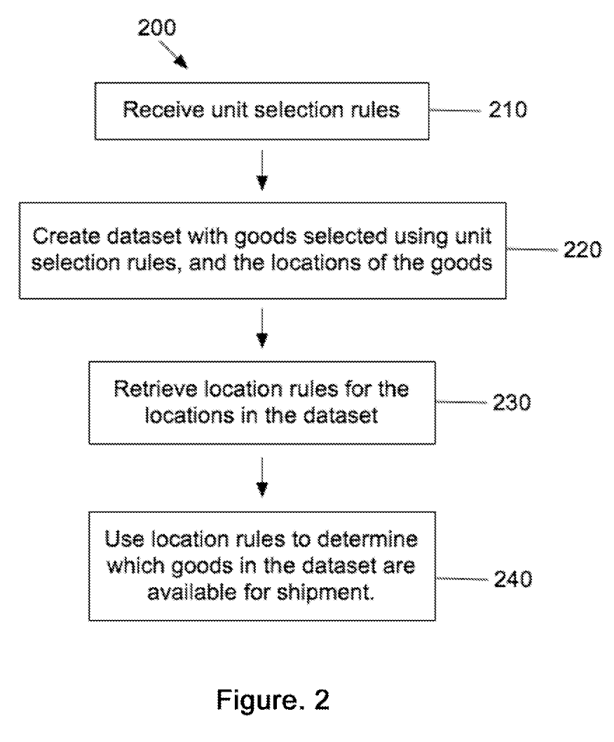

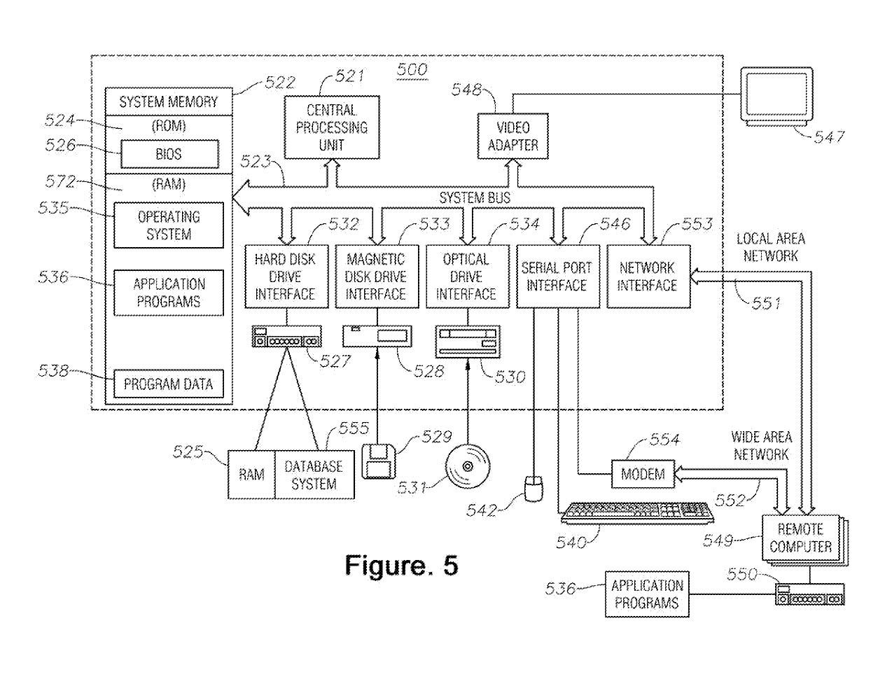

FIG. 2 illustrates a flow diagram of a method 200 for retrieving goods available for shipment in accordance with implementations of various techniques described herein. In one implementation, method 200 may be performed by any computing device, such as computer system 500, described in FIG. 5. It should be understood that while the flow diagram of method 200 indicates a particular order of execution of operations, in some implementations, certain portions of the operations may be executed in a different order. Certain portions of the operations may be executed simultaneously. Further, in some implementations, additional operations or steps may be added to the method 200 illustrated in the flow diagram. Likewise, some operations or steps may be omitted. Additionally, the operations may be executed on more than one computerized device, and the computerized devices may be in more than one location.

Method 200 may be used to retrieve goods available for shipping from a virtual warehouse 100. At block 210, method 200 may receive unit selection rules. The unit selection rules may describe a type of goods that are desired for shipping. Method 200 may receive unit selection rules used to find goods in a virtual warehouse 100. The unit selection rules may contain an identifier or attribute that identifies goods. The unit selection rules may contain serial numbers, part numbers, model numbers, dates, a manufacturer, a customer or client, locations, any other information that can be used to identify goods, or combinations thereof.

At block 220, a database may be created of goods selected using the unit selection rules, and the locations for the goods. The unit selection rules may be applied to the virtual warehouse 100 to create the database. The database may include location data for the goods. The goods may be located in more than one geographical location. For example, the database may contain goods stored in a warehouse, in transit on a train, and on store shelves. Additional information may be included in the database as well. For example, further information describing the goods may be included in the database, such as, date received, date manufactured, or other information relating to the goods.

At block 230, method 200 may retrieve location rules for the geographic locations where the goods described in the database created at block 220 are stored. The geographic locations may be retrieved from the database. The location rules corresponding to the geographic locations may be retrieved from the virtual warehouse 100, or from systems at the locations. For example, if a database created at block 220 contains five hundred goods, all of which are stored in either a warehouse or on a freight train, the location rules corresponding to the warehouse would be retrieved, and the location rules corresponding to the freight train would be retrieved. Location rules may describe whether goods stored at a geographical location can be shipped or not, or any other information corresponding to an individual location.

At block 240, the location rules retrieved at block 230 are used to determine which goods described in the database created at block 220 are available for shipment. In one example, the database created at block 220 contains two hundred goods located in a warehouse, and three hundred goods located on a freight train. In this example, the location rules state that goods in the warehouse may be shipped, but goods on the freight train may not be shipped. As such, at block 240, method 200 would determine that the two hundred goods stored in the warehouse are available for shipment. The goods available for shipment may then be stored in a database, or displayed to a user. A report may be generated describing the goods available for shipment.

In one implementation, the goods available for shipment may be ranked, and then displayed to a user. The goods may be ranked by time and date received, by location, by another attribute, or combinations thereof.

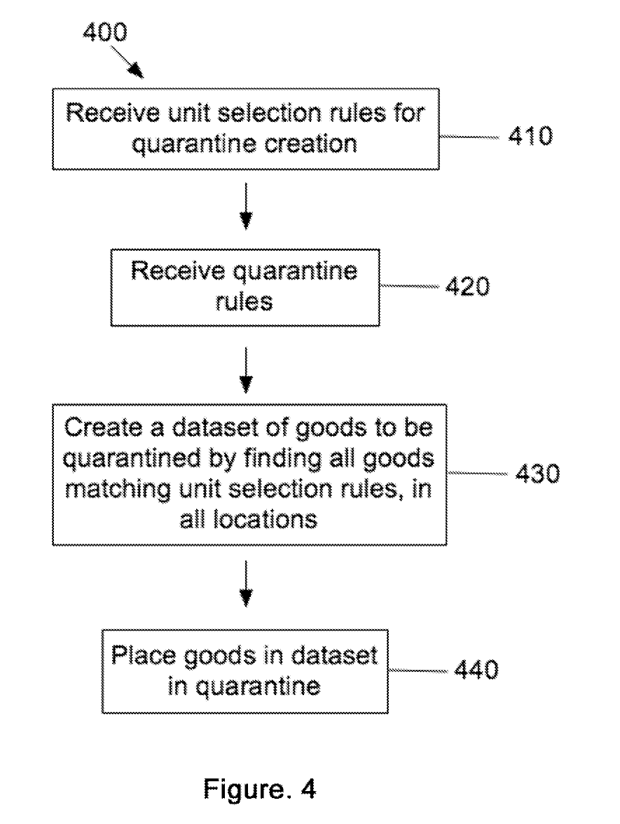

In another implementation, method 200 may determine whether any of the goods in the database created at block 220 are being held in quarantine, which is further described in FIG. 4. Method 200 may remove any goods held in quarantine from the database of the goods available for shipment, because goods held in quarantine are not to be shipped until they are removed from quarantine.

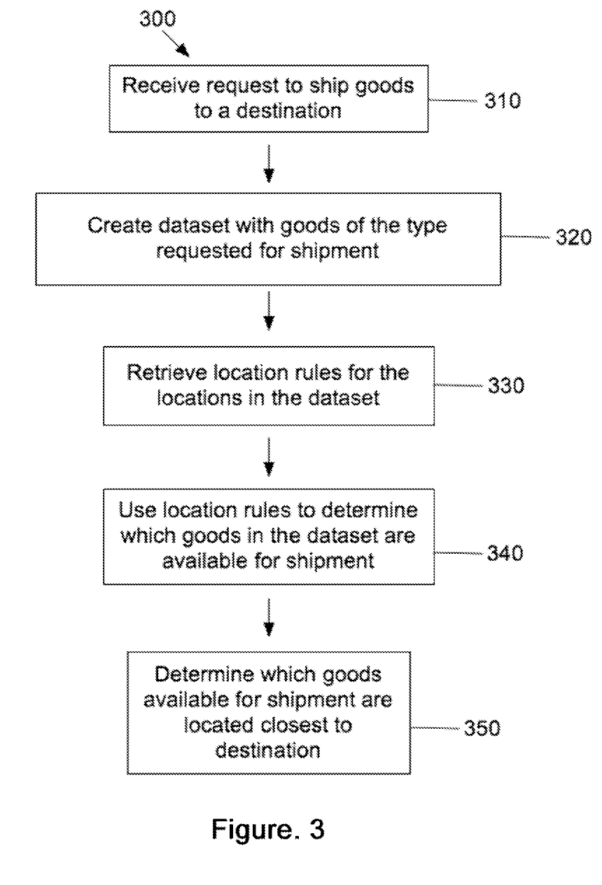

FIG. 3 illustrates a flow diagram of a method 300 for selecting goods for shipment based on destination in accordance with implementations of various techniques described herein. In one implementation, method 300 may be performed by any computing device, such as computer system 500, described in FIG. 5. It should be understood that while the flow diagram of method 300 indicates a particular order of execution of operations, in some implementations, certain portions of the operations may be executed in a different order. Certain portions of the operations may be executed simultaneously. Further, in some implementations, additional operations or steps may be added to the method 300 illustrated in the flow diagram. Likewise, some operations or steps may be omitted. Additionally, the operations may be executed on more than one computerized device, and the computerized devices may be in more than one location.

At block 310, the method may receive a request to ship goods to a destination. The request may include unit selection rules used to select goods, a destination, and a quantity of goods to ship. The goods may be selected using the unit selection rules, which may contain serial numbers, part numbers, model numbers, dates, a manufacturer, a customer or client, locations, any other information that can be used to identify goods, or combinations thereof. The destination may be a location where the goods are to be shipped. For example, the destination may be a store, warehouse, or shipping terminal.

At block 320, the method may create a database with goods of the type requested for shipment. The database may be created using the unit selection rules that describe the goods, the geographical location for each good, or both. Additional information may be included in the database as well. For example, further information describing the goods may be included in the database, such as, date received, date manufactured, or other information relating to the goods. The goods may be in multiple geographical locations. For example, the database may contain information pertaining to goods stored in a warehouse, in transit on a train, and on store shelves.

At block 330, the method 300 may retrieve location rules for the geographical locations where the goods described in the database created in block 320 are stored. The location rules may be stored within a virtual warehouse 100, or on systems located at the geographical locations. For example, if a database created at block 320 contains information pertaining to five hundred goods, all of which are stored in either a warehouse or on a freight train, the location rules corresponding to the warehouse would be retrieved, and the location rules corresponding to the freight train would be retrieved. Location rules may describe whether goods stored at a geographical location can be shipped or not, or any other information corresponding to an individual geographical location.

At block 340, the method 300 may use location rules to determine which goods in the database created at block 320 are available for shipment. In one example, the database created at block 320 contains information pertaining to two hundred goods stored in a warehouse, and three hundred goods on a freight train. In this example, the location rules state that goods in the warehouse may be shipped, but goods on a freight train may not be shipped. At block 340, method 300 would determine that the two hundred goods stored in the warehouse are available for shipment. The goods available for shipment may then be stored in a database.

In one implementation, at block 340, method 300 may also determine whether any of the goods in the database created at block 320 are being held in quarantine, further described in FIG. 4. Method 300 may remove any goods held in quarantine from the database, because goods held in quarantine are not to be shipped until they are removed from quarantine.

At block 350, method 300 may determine which goods in the database created at block 340 are located closest to the destination received at block 310. Method 300 may rank the goods by distance from destination. The goods and rankings may then be displayed to a user.

In one implementation, method 300 may examine the database created at block 340 to determine which geographical location or locations closest to the destination has the quantity of goods requested at block 310 available for shipment, and then may select those goods for shipment.

In another implementation, method 300 may examine the database created at block 340 to determine a combination of goods to be shipped that would arrive at the destination by a predetermined delivery date, and then select that combination of goods for shipment. In a third implementation, method 300 may examine the database created at block 340 to determine one or more combinations of goods that could be shipped to the destination. Method 300 may then determine the price required for shipping each combination of goods. The combinations may then be presented to a user for selection, or the cheapest combination may be automatically selected.

FIG. 4 illustrates a flow diagram of a method 400 for placing goods in quarantine in accordance with various implementations described herein. In one implementation, method 400 may be performed by any computing device, such as computer system 500, described in FIG. 5. It should be understood that while the flow diagram of method 400 indicates a particular order of execution of operations, in some implementations, certain portions of the operations may be executed in a different order. Certain portions of the operations may be executed simultaneously. Further, in some implementations, additional operations or steps may be added to the method 400 illustrated in the flow diagram. Likewise, some operations or steps may be omitted. Additionally, the operations may be executed on more than one computerized device, and the computerized devices may be in more than one location.

At block 410, method 400 may receive unit selection rules for quarantine creation. The unit selection rules may be input by a user. The unit selection rules may be automatically generated in response to an external event. The unit selection rules may describe which goods in a virtual warehouse 100 should be placed in quarantine. The rules may include serial numbers, model numbers, part numbers, locations, other attributes describing goods, or combinations thereof. For example, the unit selection rules may describe a particular model number to place in quarantine, and also state that only goods currently held in Canada should be placed in quarantine. In another example, the rules may describe a range of serial numbers, where all goods with a serial number within that range are to be placed in quarantine.

At block 420, method 400 may receive quarantine rules. Quarantine rules may describe a series of quarantine actions that should be performed on goods placed in quarantine. For example, the rules may state that no goods placed in quarantine can be moved or shipped. In a second example, the rules may state that no goods placed in quarantine can be shipped to stores. In a third example, the rules may state that all goods placed in quarantine must be shipped back to their manufacturer. In a fourth example, the rules may state that all goods placed in quarantine should be removed from their current virtual warehouse 100, and placed in a new virtual warehouse 100. The quarantine rules may be based on location, or any other attribute or combination of attributes. For example, the quarantine rules may state that all quarantined goods held in stores should be shipped to a warehouse.

At block 430, method 400 may use the unit selection rules to create a database of goods that will be placed in quarantine. The unit selection rules may be applied to a virtual warehouse 100 to create the database of goods to be placed in quarantine. The goods may be located in multiple geographical locations. For example, the unit selection rules might describe a range of serial numbers, where all goods within that range of serial numbers are placed in quarantine. The goods matching that range of serial numbers within a virtual warehouse 100 may be located in ten different warehouses, and on store shelves in three hundred different stores. All of the goods may be placed in quarantine, despite being in multiple geographical locations.

At block 440, method 400 may place the goods within the database created at block 430 in quarantine. Method 400 may use the quarantine rules received at block 420 to perform quarantine actions on the goods placed in quarantine. Method 400 may place the goods within the database created at block 430 in quarantine by making changes to a database used by a virtual warehouse 100. In a first example, if a product, i.e. a good, contained in a virtual warehouse 100 was shipped from a manufacturer to multiple warehouses, but then it was determined that the product required a firmware update, all units of the product could be placed in quarantine until the individual goods have received the firmware update. In a second example, a food product, i.e. a good, in a virtual warehouse may have been shipped from a producer to a number of geographical locations. The producer may then discover that the food product is contaminated. All units of the food product may be placed in quarantine. In both examples, while in quarantine, the quarantine rules may state that the individual goods in quarantine should not be shipped from the warehouses to store shelves. The database used by the virtual warehouse 100 may then be modified to reflect that the goods are in quarantine and should not be shipped. In the first example, once confirmation is received that an individual good in quarantine has received the firmware update, the individual good may be removed from quarantine. In the second example, an individual good that has been quarantined may be removed from both quarantine and the virtual warehouse when the individual good has been destroyed.

### Computing System

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments, including a cloud computing environment, where tasks are performed by remote processing devices that are linked through a communications network, e.g., by hardwired links, wireless links, or combinations thereof. In a distributed computing environment, program modules may be located in both local and remote computer storage media including memory storage devices.

FIG. 5 illustrates a computer system 500 into which implementations of various technologies and techniques described herein may be implemented. Computing system 500 may be a conventional desktop, a handheld device, a controller, a personal digital assistant, a server computer, an electronic device/instrument, a laptop, a tablet, or part of a cloud computing system. It should be noted, however, that other computer system configurations may be used.

The computing system 500 may include a central processing unit (CPU) 521, a system memory 522 and a system bus 523 that couples various system components including the system memory 522 to the CPU 521. Although only one CPU is illustrated in FIG. 5, it should be understood that in some implementations the computing system 500 may include more than one CPU. The system bus 523 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 522 may include a read only memory (ROM) 524 and a random access memory (RAM) 525. A basic input/output system (BIOS) 526, containing the basic routines that help transfer information between elements within the computing system 500, such as during start-up, may be stored in the ROM 524. The computing system may be implemented using a printed circuit board containing various components including processing units, data storage memory, and connectors.

The computing system 500 may further include a hard disk drive 527 for reading from and writing to a hard disk, a magnetic disk drive 528 for reading from and writing to a removable magnetic disk 529, and an optical disk drive 530 for reading from and writing to a removable optical disk 531, such as a CD ROM or other optical media. The hard disk drive 527, the magnetic disk drive 528, and the optical disk drive 530 may be connected to the system bus 523 by a hard disk drive interface 532, a magnetic disk drive interface 533, and an optical drive interface 534, respectively. The drives and their associated computer-readable media may provide nonvolatile storage of computer-readable instructions, data structures, program modules and other data for the computing system 500.

Although the computing system 500 is described herein as having a hard disk, a removable magnetic disk 529 and a removable optical disk 531, it should be appreciated by those skilled in the art that the computing system 500 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 500. Communication media may embody computer readable instructions, data structures, program modules or other data in a modulated data signal, such as a carrier wave or other transport mechanism and may include any information delivery media. By way of example, and not limitation, communication media may include wired media such as a wired network or direct-wired connection, and wireless media such as acoustic, RF, infrared and other wireless media. Combinations of any of the above may also be included within the scope of computer readable media.

A number of program modules may be stored on the hard disk 527, magnetic disk 529, optical disk 531, ROM 524 or RAM 525, including an operating system 535, one or more application programs 536, program data 538, and a database system 555. The one or more application programs 536 may contain program instructions configured to perform methods 200, 300, or 400 according to various implementations described herein. The operating system 535 may be any suitable operating system that may control the operation of a networked personal or server computer, such as Windows® XP, Mac OS® X, Unix-variants (e.g., Linux® and BSD®), and the like.

A user may enter commands and information into the computing system 500 through input devices such as a keyboard 540 and pointing device 542. Other input devices may include a microphone, joystick, game pad, satellite dish, scanner, user input button, or the like. These and other input devices may be connected to the CPU 521 through a serial port interface 546 coupled to system bus 523, but may be connected by other interfaces, such as a parallel port, game port or a universal serial bus (USB). A monitor 547 or other type of display device may also be connected to system bus 523 via an interface, such as a video adapter 548. In addition to the monitor 547, the computing system 500 may further include other peripheral output devices such as speakers and printers.

Further, the computing system 500 may operate in a networked environment using logical connections to one or more remote computers 549. The logical connections may be any connection that is commonplace in offices, enterprise-wide computer networks, intranets, and the Internet, such as local area network (LAN) 551 and a wide area network (WAN) 552. The remote computers 549 may each include application programs 536 similar to that as described above.

When using a LAN networking environment, the computing system 500 may be connected to the local network 551 through a network interface or adapter 553. When used in a WAN networking environment, the computing system 500 may include a modem 554, wireless router or other means for establishing communication over a wide area network 552, such as the Internet. The modem 554, which may be internal or external, may be connected to the system bus 523 via the serial port interface 546. In a networked environment, program modules depicted relative to the computing system 500, or portions thereof, may be stored in a remote memory storage device 550. It will be appreciated that the network connections shown are exemplary and other means of establishing a communications link between the computers may be used.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A non-transitory computer-readable medium having stored thereon computer-executable instructions which, when executed by a computer, cause the computer to:
receive a request to ship a predetermined number of a type of goods to a destination location;
identify a selection of goods that correspond to the requested type of goods from a database containing a plurality of goods that are physically stored in more than one geographical location; and
determine which of the selection of goods are available to be shipped to the destination location based on one or more rules for the geographical locations of the selection of goods, wherein the one or more rules dictate whether goods can be shipped from the geographical locations to the destination location.

2. The non-transitory computer-readable medium of claim 1, wherein the more than one geographical location comprises more than one physical warehouse, store, transportation vehicle, or combinations thereof.

3. The non-transitory computer-readable medium of claim 1, wherein the more than one geographical location comprises a location managed by a third party logistics provider.

4. The non-transitory computer-readable medium of claim 1, wherein the executable instructions that determine which of the selection of units are available to be shipped comprise instructions that cause the computer to exclude goods that are in quarantine from the selection of goods that are available to be shipped.

5. The non-transitory computer-readable medium of claim 1, further comprising instructions that cause the computer to rank the selection of goods available to be shipped by time and date received.

6. The non-transitory computer-readable medium of claim 5, further comprising instructions that cause the computer to modify the selection of goods available to be shipped based on the rank.

7. The non-transitory computer-readable medium of claim 1, further comprising instructions that cause the computer to rank the selection of goods available to be shipped by geographical location.

8. The non-transitory computer-readable medium of claim 7, further comprising instructions that cause the computer to modify the selection of units available to be shipped based on the rank.

9. A non-transitory computer-readable medium having stored thereon computer-executable instructions which, when executed by a computer, cause the computer to:
receive a request to place a type of goods in quarantine;
identify a selection of goods that correspond to the requested type of goods from a database containing a plurality of goods that are physically stored in more than one geographical location; and
modify the database to indicate that the selection of goods is in quarantine and not to be shipped.

10. The non-transitory computer-readable medium of claim 9, further comprising instructions that cause the computer to remove entries corresponding to the goods in quarantine from the database.

11. The non-transitory computer-readable medium of claim 10, further comprising instructions that cause the computer to:
receive confirmation that the goods in quarantine should no longer be in quarantine; and
add entries corresponding to the goods in quarantine to the database.

12. The non-transitory computer-readable medium of claim 9, wherein the more than one geographical location comprises more than one physical warehouse, store, transportation vehicle, or combinations thereof.

13. The non-transitory computer-readable medium of claim 9, wherein the more than one geographical location comprises a location managed by a third party logistics provider.

14. The non-transitory computer-readable medium of claim 9, further comprising instructions that cause the computer to:
receive confirmation that the goods in quarantine should no longer be in quarantine; and
modify the database to indicate that the selection of goods is no longer in quarantine.

15. The non-transitory computer-readable medium of claim 9, further comprising instructions that cause the computer to:
receive confirmation that the goods in quarantine should no longer be in quarantine; and
modify the database to indicate that the selection of goods is available for shipment.

16. A non-transitory computer-readable medium having stored thereon computer-executable instructions which, when executed by a computer, cause the computer to:
receive a request to ship a predetermined number of a type of goods to a destination location;
identify a selection of goods that correspond to the requested type of goods from a database containing a plurality of goods that are physically stored in more than one geographical location;
determine which of the selection of goods are available to be shipped to the destination location based on one or more rules for the geographical locations of the selection of goods, wherein the one or more rules dictate whether goods can be shipped from the geographical locations to the destination location; and
rank the goods within the selection that are available to be shipped based on their distance from the destination location.

17. The non-transitory computer-readable medium of claim 16, further comprising instructions that cause the computer to determine the location closest to the destination location that contains the predetermined number of goods that are available to ship.

18. The non-transitory computer-readable medium of claim 16, wherein the more than one geographical location comprises more than one physical warehouse, store, transportation vehicle, or combinations thereof.

19. The non-transitory computer-readable medium of claim 16, wherein the more than one geographical location comprises a location managed by a third party logistics provider.

20. The non-transitory computer-readable medium of claim 16, wherein the executable instructions that determine which of the selection of goods are available to be shipped comprise instructions that cause the computer to exclude goods that are in quarantine from the selection of goods that are available to be shipped.
